(19) United States
(12) Patent Application Publication
(10) Pub. No.: US 2015/0279213 A1
(43) Pub. Date: Oct. 1, 2015

(54) Parking Spot Coordination System

(71) Applicant: S-PARKING TECHNOLOGIES LTD., Tel Aviv (IL)

(72) Inventors: Eran Balter, Tel Aviv (IL); Tal Dekel, Tel Aviv (IL)

(21) Appl. No.: 14/433,716

(22) PCT Filed: Nov. 6, 2013
(86) PCT No.: PCT/IB2013/059938

§ 371 Date: Apr. 6, 2015

Related U.S. Application Data
(60) Provisional application No. 61/722,799, filed on Nov. 6, 2012.

(51) Int. Cl. G08G 1/14; G01S 19/14; G07B 15/02; G01C 21/36

(52) U.S. Cl. CPC G08G 1/143; G01C 21/36; G01S 19/14; G07B 15/02

(57) ABSTRACT

An embodiment of the invention relates to a parking spot identification system and method for providing parking-related information to a user seeking parking, hereinafter referred to as a “seeker.” The system enables a seeker to reduce time and energy spent looking for a parking spot and generally reduces distance between seeker's destination and the parking spot. In an embodiment the method comprises receiving a request from a seeker to park in an area, the request having a parking constraint; receiving an indication of a possibility of a parking spot being vacated by an occupier whose vehicle is parked in a parking spot meeting the parking constraint, and providing information to the seeker regarding the occupier once the probability of an occupier spot being vacated has exceeded a predetermined level.

### RELATED APPLICATIONS

The present application claims the benefit under 35 U.S.C. 119(e) of U.S. Provisional Application 61/722,799 filed on Nov. 6, 2012, the disclosure of which is incorporated herein by reference.

### TECHNICAL FIELD

An embodiment of the invention relates to systems for providing parking-related information.

### BACKGROUND

In many urban areas, the number of parking spots at certain times of a day is not sufficient to accommodate all of the vehicles of people who wish to find parking in proximity to their destinations. As a result, many drivers “cruise” around urban areas looking for parking spots, often spending extended periods of time driving slowly while looking for street parking or lots with open spots. Extensive cruising of city streets may cause multiple problems including increased pollution and traffic congestion. In addition, cruisers may cause traffic accidents by focusing their attention on finding parking spots instead of on driving.

Although paid, off-street parking lots are available in some urban areas, the cost of parking in such lots is often higher than the cost of street parking. In addition, off-street parking may be far from a destination, and a driver may not be familiar with off-street parking options. In a crowded urban area, a driver may cruise city streets looking for an inexpensive parking spot for extended periods of time while wasting gasoline as a result of cruising, then after an extended search, enter a paid off-street parking lot and pay high hourly rates for parking. Such situations are often frustrating to drivers. In addition, extended delays stemming from looking for parking may result in late arrival at appointment in city centers.

In some situations, while en route to a destination, a driver may find a parking spot far from his destination and may resort to parking there as a result of fear of not finding a spot closer to the destination. The driver will then walk a far distance to the destination while passing many available parking spots closer to the destination that the driver did not know about at the time of parking.

### SUMMARY

An embodiment of the invention relates to a parking spot identification system hereinafter referred to as a “ParkSIS”, for providing parking-related information to a user seeking parking, hereinafter referred to as a “seeker.” ParkSIS enables a seeker to reduce time and resources spent looking for a parking spot and generally reduce distance between the seeker's destination and the parking spot.

In an embodiment of the invention, ParkSIS receives a request from a seeker to park in proximity to a location and receives an indication of a parking spot potentially being vacated by a user, hereinafter referred to as an “occupier,” parked in a parking spot in proximity to the location. ParkSIS calculates the probability of matching the seeker with the spot being vacated at the time of vacating and alerts the seeker regarding current or future vacancy of parking spaces in proximity to the location. The seeker and/or occupier may convey information to and/or receive information from ParkSIS using a mobile communication device, for example a mobile phone. The mobile communication device may have a data connection to transfer data to and from wired databases and may connect to ParkSIS via internet and/or through a mobile application.

In an embodiment of the invention, ParkSIS receives an indication of a parking spot potentially being vacated by an occupier through a parking spot vacating identification function, hereinafter referred to as a “VIF.” The VIF may determine a probability of an occupier vacating a parking spot within a given period of time before the occupier vacates the parking spot, optionally without requiring the occupier to actively engage the VIF. The VIF may use a mobile communication device, for example a mobile phone, to recognize occupier movement and/or location and/or sound generated by the occupier, the occupier's environment or an environment of the parking spot to determine a probability of an occupier vacating his or her parking spot. In addition, an occupier's past movement may be used by ParkSIS to predict occupier's future vacating of a parking spot.

In an embodiment of the invention, ParkSIS receives an indication of a potential seeker looking for a parking spot through a seeking identification function, hereinafter referred to as a “SIF.” SIF may identify a seeker looking for a parking spot optionally without requiring the occupier to actively engage ParkSIS. The SIF may use a mobile communication device, for example a mobile phone, to recognize occupier movement, and/or location, and/or sound, generated by the occupier, the occupier's environment or an environment of the parking spot to determine a presence of a seeker looking for a parking spot. Upon SIF detecting a seeker looking for a parking spot, ParkSIS may use SIF to coordinate matching between the seeker and an occupier. Upon determination of a probability of matching a potential seeker with a potential occupier, ParkSIS may prompt the potential seeker and/or the potential occupier to coordinate transfer of occupancy or of parking-related information, collectively known as, “hand off” of a parking spot from the occupier to the seeker.

According to an embodiment of the invention, upon determination of a potential match between a seeker with an occupier, ParkSIS may plan a route which seeker is to traverse to encounter destinations of maximal probability of handing off a parking spot. According to an embodiment of the invention, the route is planned to minimize idling time of a seeker waiting for a potential occupier. Preferably, idling time may be less than 30 seconds. According to an embodiment of the invention, idling time may be less than 15 seconds, or less than 10 seconds.

Other navigation systems known in the art may allow for a user to navigate to a specific location based on a “shortest route,” which traverses least distance from user's start to user's destination, or a “fastest route” which enables a user to traverse the distance from his location to his destination in the least possible time, based on historical and real time information relating to traffic. ParkSIS, according to embodiments of the invention, allows a seeker to traverse a “highest parking probability route with minimum vehicle idling” by providing a route plan that coordinates the seeker (or multiple seekers) and occupier (or multiple occupiers) arrival at a parking destination with a minimal time interval between the arrivals, by devising a route plan for the seeker that minimizes the difference between predicted arrival times of seeker and occupier at a parking spot, by taking into account parameters such as but not limited to the time it takes the occupier to arrive at his/her vehicle, the time it takes the occupier's vehicle to leave the parking-spot, the time it takes the seeker to arrive at the road-segment of the parking-spot, where he/she can detect the occupier on his/her way to leave the parking spot.

According to an embodiment of the invention, parking information may be provided to ParkSIS and/or by ParkSIS in terms of road segments. A road segment may be an area of a road between two points in which a driver may travel in a single, predetermined direction, without the possibility of veering from the road segment. For a given destination of parking requested by a seeker, ParkSIS may calculate probability of a seeker finding a parking spot by analyzing and comparing probability of finding a parking spot for each individual road segment, and allowing to compensate for small time differences between seeker's and occupier's arrivals in cases where the seeker and occupier are progressing at the same road-segment at the same direction towards the parking spot, allowing the seeker to customize his/her driving speed in order to secure the handoff with the presumed occupier prior to arrival at the parking spot. Additionally, providing information at a road segment level enhances an occupier's parking location privacy by exposing to ParkSIS users the aggregate parking spot information on the road-segment rather than correlating a specific occupier to a specific parking location.

According to an embodiment of the invention, information relating to a seeker with a specific vehicle length that passes through a road-segment having a certain distance to his/her destination correlated with ParkSIS parking categorization method described herein reveals whether that seeker parked in a specific road-segment. In a situation or situations where a user did not park in the road segment, information may be provided to ParkSIS indicating absence of a parking spot with the seeker's vehicle length at that traversed road-segment. This information may then be used by ParkSIS in real-time to devise a route plan for additional seekers.

A user of a navigation system is typically not accustomed to stop during his travel route to idle his vehicle. According to embodiments of the invention, users of ParkSIS may experience a user experience which does not significantly alter their driving pattern and does not require them to stop for a significant time period, for example, more than 30 seconds, during a travel route to find a parking spot. Users are more likely to adopt a navigation system such as ParkSIS which does not significantly interfere with the users' driving patterns.

Many ParkSIS users may simultaneously be seekers or occupiers of a parking spot or parking spots in a similar area such as a city center, according to embodiments of the invention. According to an embodiment of the invention, ParkSIS may process requests for parking on an aggregate basis in order to reduce overall time of seeking parking spots for all users in a given area, thereby reducing traffic congestion in the given area.

In an embodiment of the invention, the ParkSIS suggests a travel route to a seeker, the route passing in proximity to parking spots that match the seeker's parking needs and have a high probability of being vacant at the time the seeker traverses the route.

In an embodiment of the invention, ParkSIS facilitates communication between the seeker and the occupier in order to coordinate hand off of a parking spot.

In an embodiment of the invention, ParkSIS allows a user to “subscribe” to updates regarding other users' seeking and/or vacating parking spots in a given area, and facilitates communication between users.

In an embodiment of the invention, ParkSIS stores historical data relevant to on-street and/or off-street parking spots in proximity to a location, thereby generating a parking spot database, hereinafter referred to as a “PSD.” A seeker may access data in the PSD either actively, or through ParkSIS initiation, in order to receive data, for example, probability of finding a vacated parking spot within a certain proximity of a location at a certain time based on the historical data stored in the PSD. Optionally, the ParkSIS may alert a seeker of parking restrictions based on historical data stored in the PSD.

A ParkSIS seeker may indicate at least one constraint relating to his or her parking request. The constraint may relate to a time and/or a location of desired parking. The constraint may be an estimated time of arrival at a location generated by ParkSIS as a function of the time of departure added to the estimated time of travel to a location. The constraint may be a location within a certain radius of the destination of the ParkSIS seeker. For example, the constraint may be any location within 200 meters walking distance from a destination of a ParkSIS user.

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIGS. 1A, 1B, 1C, 1D and 1E schematically show urban areas in which ParkSIS may be used to suggest matching of users to facilitate hand off of parking spots, in accordance with embodiments of the invention;

FIG. 2 schematically shows components of a ParkSIS system in accordance with an embodiment of the invention;

FIG. 3A schematically shows a flow diagram describing operation of a ParkSIS system in accordance with an embodiment of the invention; and

FIG. 3B schematically shows a diagram of ParkSIS user states during the operation of ParkSIS, in accordance with an embodiment of the invention.

### DETAILED DESCRIPTION

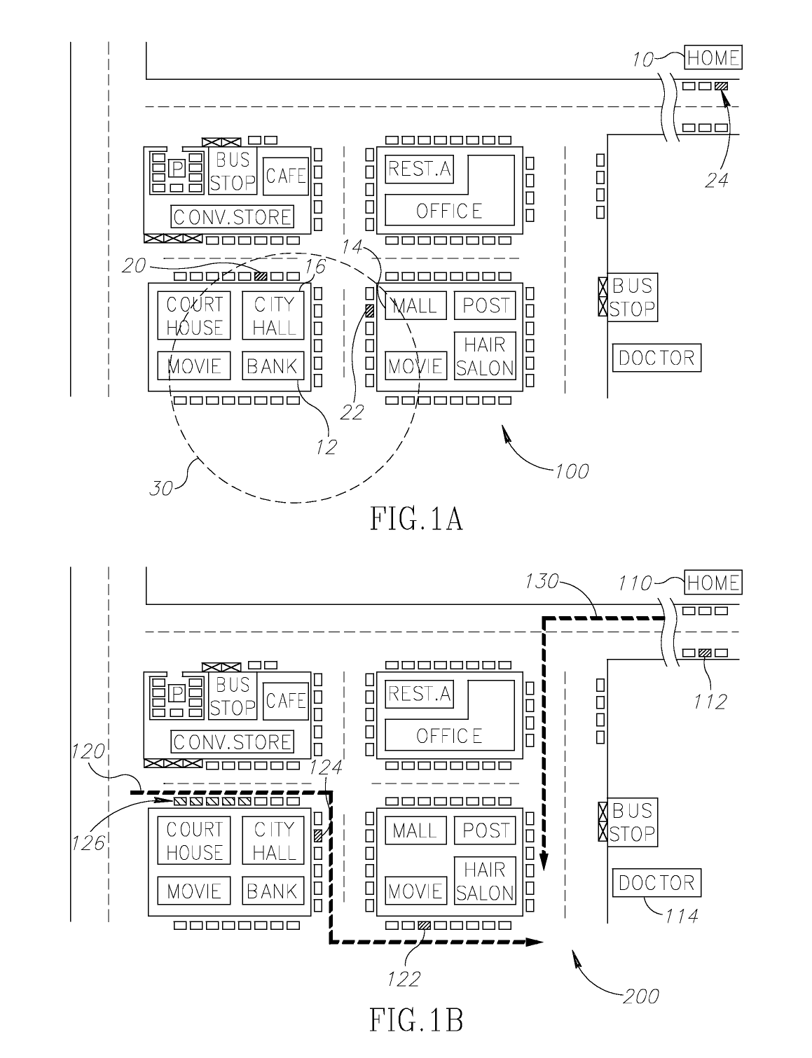

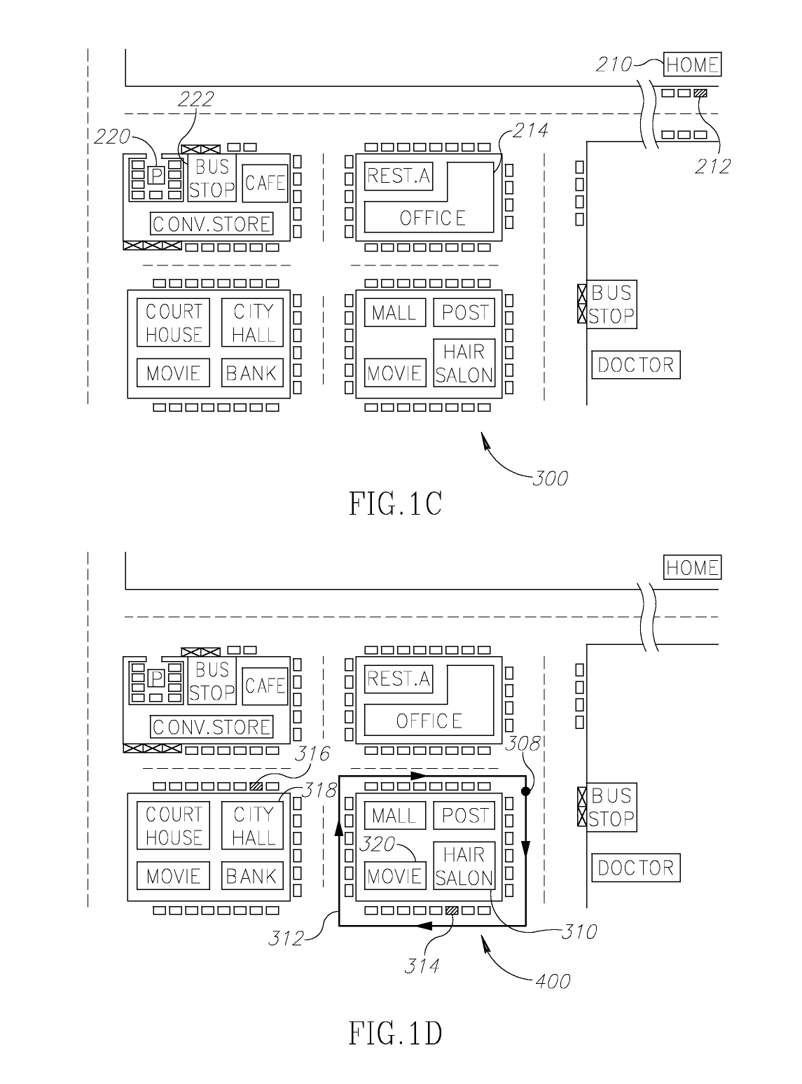

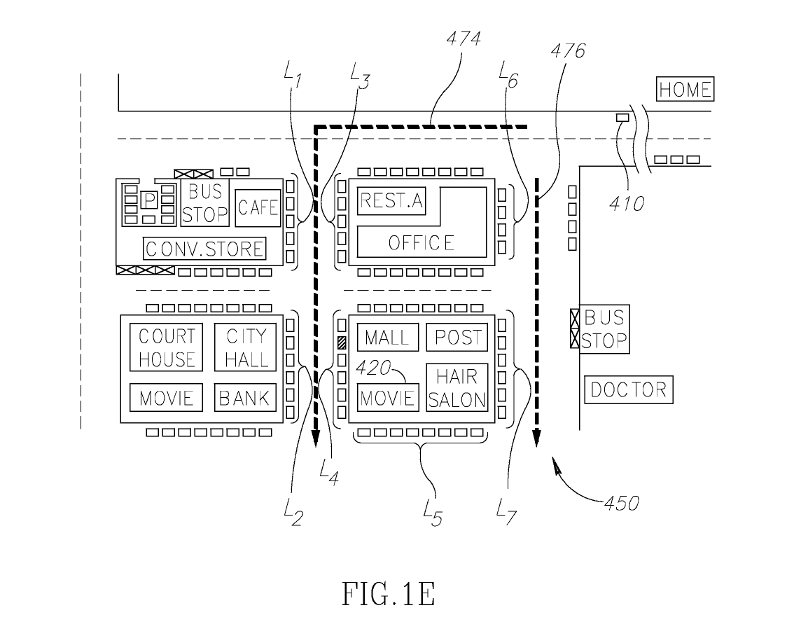

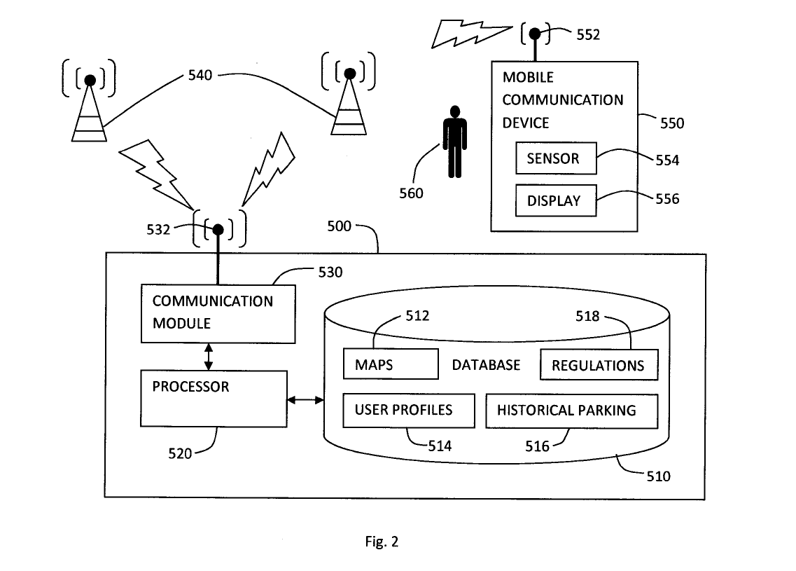

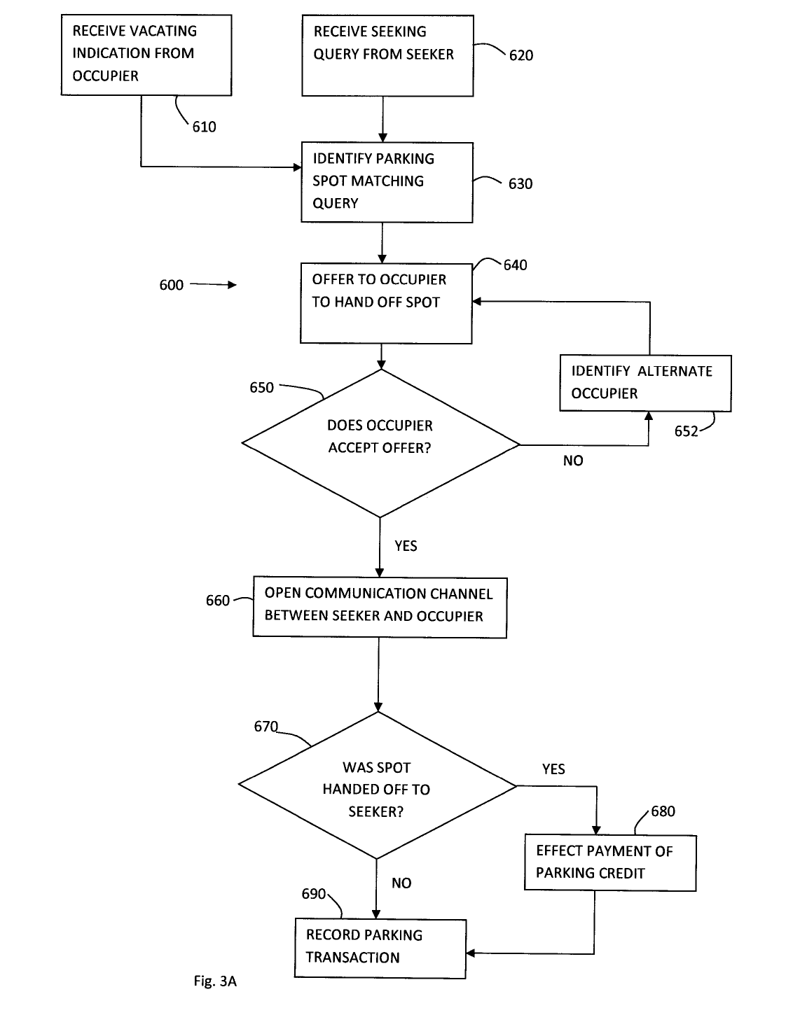

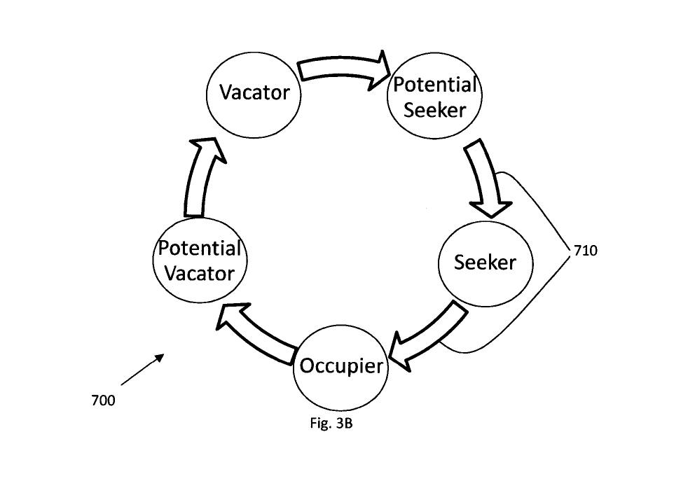

In the following detailed description, hypothetical scenarios involving operation of ParkSIS, in accordance with an embodiment of the invention, are discussed with reference to FIGS. 1A, 1B, 1C 1D and 1E. Components of a ParkSIS system in accordance with embodiments of the invention are schematically shown in FIG. 2. A flow diagram depicting an algorithm performed by ParkSIS in accordance with an embodiment of the invention is shown in FIG. 3A, and a state diagram describing user states during operation of ParkSIS in accordance with an embodiment of the invention is shown in FIG. 3B.

FIG. 1A schematically shows an urban area 100 comprising a home 10, a bank 12, a mall 14, a city hall 16, a parking spot 20, a parking spot 22 and a parking spot 24.

A seeker located at home 10, engages ParkSIS via his mobile device, on Jan. 10, 2012 at 10:45 AM, before departing from home 10 with intention to obtain a parking spot within proximity to bank 12, based on his understanding of limited available parking in urban area 100 during morning hours on a workday. Seeker's mobile phone is equipped to use a wireless location technology, for example, a global positioning system (GPS) tracker system, a cellular network tracker system, a wireless local area network system (wi-fi) system and any combination of these systems.

In an embodiment of the invention, the seeker engages ParkSIS via a mobile device such as a mobile phone, a smartphone, personal digital assistant (PDA), laptop computer or a tablet computer.

The seeker conveys information to ParkSIS relating his intention to park, hereinafter referred to as “parking request,” in close proximity to bank 12. In an embodiment of the invention, the seeker inputs name or address of bank 12 into ParkSIS to generate a parking request. In an embodiment of the invention, the seeker selects bank 12 as location of interest from a list of recent or preferred destination locations provided by ParkSIS to generate a parking request.

ParkSIS defines a preferred parking area 30 as a circular area having its center at location of interest (bank 12) and having a radius of a preferred parking distance. Preferred parking distance is the maximum distance that the seeker has defined as distance that he is willing to park from a given location of interest. In an embodiment of the invention, the seeker defines his preferred parking distance upon initiation of ParkSIS, thereby defining a user profile stored by ParkSIS, obviating the need to re-enter a preferred parking distance upon subsequent transmission of parking requests. Optionally, the user profile can include user information including: place of work, preferred travel times, preferred travel locations, vehicle color, vehicle manufacturer, vehicle model, maximum payment amount for a parking spot and vehicle length.

In an embodiment of the invention, the user defines multiple levels of preference of parking distance. For example, a most preferred parking distance may be defined as within about 100 meters, and a secondary preferred parking distance may be defined as within about 300 meters.

ParkSIS determines, based on distance, historical traffic data, user profile (see also FIG. 2), historical driving patterns of seeker, real time traffic data or any combination of these parameters, estimated time of arrival of seeker at bank 12.

In an embodiment of the invention, seeker communicates his intended time of arrival at bank 12 to ParkSIS via a parking request.

Upon receipt of parking request from seeker, ParkSIS identifies ParkSIS users parked within preferred parking area 30 as occupiers with a possibility of vacating parking spots within preferred parking area 30 at the estimated time of arrival of seeker using a VIF function in mobile phones of users. ParkSIS determines that occupier cars are approximately the same size or larger than seeker's car in order to ascertain that occupiers' parking spots are sufficiently large as to allow for parking of seeker's car. ParkSIS identifies occupier A, who has been identified by VIF parking in parking spot 22 at 9:58 AM and entering mall 14 at 10:00 AM. ParkSIS also identifies occupier B who has been recorded by VIF parking in parking spot 20 at 8:58 AM and entering city hall 16 at 9:00 AM.

VIF, through monitoring various parameters on occupiers' respective mobile phones, identifies location of occupiers, of occupiers' parking spot and probabilities of vacating parking spot using occupier movement and/or present or historical location and/or occupier heuristics including sound generated by the occupier, the occupier's environment or an environment of the parking spot to determine presence of an occupier vacating his or her parking spot. In addition, an occupier's past movement may be used by ParkSIS to predict occupier's future vacating of a parking spot.

In an embodiment of the invention, if ParkSIS is not successful in identifying ParkSIS users within preferred parking area 30, ParkSIS may identify ParkSIS users within a secondary preferred parking distance from bank 12.

Upon identification of occupiers with potential of vacating parking spots within preferred parking area 30, ParkSIS optionally alerts seeker of potential parking matches within preferred parking area 30.

At 10:46 AM, the seeker moves his car from parking spot 24 and begins travel in the direction of bank 12. ParkSIS stores time and location information regarding vacating of parking spot 24 in PSD. Upon receipt of parking request from seeker, ParkSIS updates other users seeking parking in vicinity of parking spot 24 regarding vacating of parking spot 24.

At 10:55 AM, the seeker's location is determined by ParkSIS to be within 1 kilometer of bank 12. At 10:55 AM, a change in location of mobile phone of occupier A, which is connected to wi-fi network in mall 14, is detected using motion detection devices, for example, an accelerometer located within occupier A's mobile phone. The change in strength of wi-fi network connection and detected motion indicate to VIF increased probability of occupier A vacating parking spot 22.

At 10:56 AM, seeker's location is determined by ParkSIS to be within 800 meters of bank 12. At 10:56 AM, mobile phone of occupier A disconnects from wi-fi network in mall 14 and signal strength from cellular network increases. The change in network connection strength indicates to VIF a potential move of occupier A from indoors to outdoors in the direction of his parked car, indicating an increased probability of occupier A of vacating parking spot 22.

At 10:56 AM, location of occupier B is determined by VIF to be in city hall 16. No changes in mobile phone of occupier B network connection or motion are detected. PSD historical data suggests that occupier B frequently leaves city hall 16 at about 11:00 AM, proceeds to his vehicle parked in the vicinity of city hall 16, and drives his car about 5 kilometers to a golf course for about 1.5 hours.

At 10:57:00 AM, ParkSIS prompts occupier A and occupier B through their respective mobile phones regarding vacating their respective parking spots. In an embodiment, the ParkSIS prompts occupiers with a pop-up notification conveying the message, “A seeker is approaching the area of your parked vehicle. Will you be vacating your parking spot at about 11:00 AM?” In an embodiment of the invention, the pop-up notification comprises touch screen icons labeled with words “yes,” “no” and “ignore,” which can be pressed by the occupier to indicate his answer to the ParkSIS prompt, thereby notifying ParkSIS of his intention.

In an embodiment of the invention, ParkSIS prompts occupiers through an audible tone, a vibration, a voice message, an e-mail message or a text message.

At 10:57:15 AM, occupier A communicates to ParkSIS via his mobile phone that he will be leaving parking spot 22 at about 11:00 AM. At 10:57:20 AM, ParkSIS locates seeker and communicates to occupier A information regarding seeker's current location, estimated time to parking spot 22, and type of vehicle including color, manufacturer and model, as per seeker's user profile. At 10:57:20, ParkSIS communicates to seeker that a matching occupier has been found who will be vacating a parking spot within preferred parking area 30. ParkSIS optionally communicates to seeker location of parking spot 22, estimated time of arrival of occupier A to parking spot 22, identification information regarding car parked in parking spot 22. In an embodiment of the invention, ParkSIS displays a map of vicinity of parking spot 22, optionally comprising a display of the location of parking spot 22 visually distinct from its surrounding environs.

In an embodiment of the invention, at 10:57:20 AM, ParkSIS prompts occupier A with a request to confirm that occupier A's car is parked in parking spot 22. Upon receipt of confirmation from occupier A, ParkSIS then proceeds to inform seeker information regarding matching occupier A.

In an embodiment of the invention, a direct communication channel is opened between occupier A and seeker upon occupier A's indication to vacate parking spot 22. The communication channel allows occupier and seeker to communicate before hand off of parking spot without requiring identification of seeker's or occupier's name or phone contact information. In an embodiment of the invention, the communication channel is a chat window, a voice conversation or a message box. In an embodiment of the invention, the voice conversation is initiated through the ParkSIS application without requiring transfer of telephone number between users.

In an embodiment of the invention, ParkSIS users are given virtual credit or tokens to be associated with their respective user profiles upon initiation of ParkSIS usage, to be used for payment in exchange for parking spot hand offs. Occupiers may be awarded credit for successful handing off of parking spots to seekers. Optionally, occupiers may be awarded credit for informing ParkSIS of intention to vacate a parking spot even if no successful hand off of a parking spot to a seeker occurs. A virtual price of a parking spot in virtual credit or tokens may be determined based on demand. For example, at times where there are many seekers looking for parking spots in a given area, a virtual price of a parking spot will increase in that area.

In an embodiment of the invention, a ParkSIS user may purchase tokens by a monetary payment to a ParkSIS operator, for example, via credit card or electronic wallet service in order to add tokens to his user profile.

In an embodiment of the invention, ParkSIS users may gain virtual credit or tokens or may improve user's rating by reporting vacant parking spots in urban areas to ParkSIS.

In an embodiment of the invention, before offering to seeker a matching parking spot, ParkSIS prompts seeker with a message conveying virtual price and asking seeker if he is interested in obtaining a parking spot for the virtual price. ParkSIS proceeds with offering to seeker the parking spot if seeker agrees to pay the virtual price.

In an embodiment of the invention, seeker sets a maximum virtual price that he is willing to spend via his user profile in ParkSIS. At the time seeker requests parking, ParkSIS offers to seeker parking spots for a virtual price of lower than seeker's threshold.

At 10:58:00 AM, occupier A arrives at parking spot 22 and waits for the arrival of seeker. Seeker arrives next to parking spot 22 at 10:59:00 and identifies occupier A's car based on description of location and/or car characteristics received from ParkSIS. After making eye contact or verbal contact with seeker, occupier A enters his car and moves out of parking spot 22, allowing seeker to enter parking spot 22.

At 11:00, upon recognition of seeker parking at parking spot 22 using VIF, ParkSIS prompts seeker and/or occupier A to inquire if parking hand off from occupier A was successful. Upon receipt of confirmation of parking spot hand off, ParkSIS credits occupier A user profile with virtual credit or tokens and detracts virtual credit or tokens from seeker's user profile.

In an embodiment of the invention, in order to obviate hand or eye contact between seeker and occupier, ParkSIS indicates to occupier A that seeker is located in immediate vicinity of parking spot 22 and is prepared to enter parking spot 22. Occupier A indicates, for example, via a button on his cellular phone, that he is preparing to exit parking spot 22. Seeker is then asked if he entered parking spot 22. Upon indicating entering parking spot 22, credit is transferred based on successful hand off.

In an embodiment of the invention, information regarding seeker location in real time is displayed visually on occupier's mobile communications device, and information regarding occupier's location in real time is displayed visually on occupier's mobile communications device, for example, using augmented reality technology.

In an embodiment of the invention, seeker or occupier is prompted by ParkSIS to rate the parking hand off based on parameters such as timeliness and courtesy of the other user in the hand off. For example, if seeker was impressed by occupier A's courtesy and timeliness, seeker may rate occupier A with a high rating. ParkSIS may optionally reward occupier A with additional “bonus” virtual credit or tokens based on receipt of a high rating. Alternatively, in situations in which multiple seekers are deemed by ParkSIS to be potential matches for one parking spot, ParkSIS may prefer to offer the parking spot to the seeker having a higher rating based on previous parking hand offs than to the seeker having a lower rating.

In an embodiment of the invention, ParkSIS may automatically determine non-completion of a hand off, for example, if the seeker leaves location of hand off during transaction before arrival of occupier to complete the hand off. In an embodiment of the invention, a user may be penalized for not completing a hand off of a parking spot. For example, if a seeker initiates a process using ParkSIS and accepts an offer to occupy a parking spot, then does not occupy it, seeker may be charged for the hand off, even though he did not occupy the parking spot. In addition, a user's rating may be lowered based on canceling hand offs which have been initiated.

In an embodiment of the invention, ParkSIS offers a parking spot to a seeker based on seeker's intended length of parking occupation. For example, if a number of seekers are seeking a parking spot in vicinity of parking spot 22, ParkSIS may ask the seekers how long they each intend to park in the vicinity. ParkSIS may prioritize hand off with a seeker who designated least parking time, in order to maximize number of parking hand offs per day, thereby maximizing ParkSIS potential revenue.

At 11:00 AM, upon recognition of seeker parking at parking spot 22 using VIF, ParkSIS determines probability of hand off of parking spot 22 from seeker to additional seekers. Optionally, ParkSIS updates PSD of transaction history and parking space occupancy regarding parking spot 22.

According to an embodiment of the invention, a probability is determined using a mathematical model. The mathematical model may be based on one or more of the following: autoregressive-moving average model (ARMA), autoregressive fractionally integrated moving average model (ARFIMA) or other models. The mathematical model considers parameters of the PSD such as, but not limited to the parking nature of a specific occupier, the parking nature of a specific area or road-segment, the probability of a user walking towards his car to actually leave his/her parking spot. According to an embodiment of the invention, ParkSIS coordinates a transaction between a seeker and an occupier if probability of hand off of parking speed exceeds a level predetermined by ParkSIS. According to an embodiment of the invention, the probability of handoff is about 50%, about 60%, about 70%, about 80% or about 90%.

Many ParkSIS users may simultaneously be seekers or occupiers of parking spots in a similar area such as a city center, according to embodiments of the invention. According to an embodiment of the invention, ParkSIS may process requests for parking on an aggregate basis in order to reduce overall time of seeking parking spots for all users in a given area, thereby reducing traffic congestion in the given area. For example, in a scenario, a seeker “A” is located at an approximate travel time of 15 seconds from a potential parking spot “1” and 30 seconds from a potential parking spot “2”. Seeker “B” is located at an approximate travel time of 30 seconds from potential parking spot “1” and 40 seconds from potential parking spot “2” assuming that the probability of each seeker matching in each spot is equal. ParkSIS may direct seeker “A” to parking spot “1” and seeker “B” to parking spot “2.” Aggregate time of seekers' parking waiting in such a situation is 55 seconds. If ParkSIS were to direct seeker “A” to parking spot “2” and seeker “B” to parking spot “1,” aggregate time of seekers' waiting would be 60 seconds. Minimizing aggreagate seeking time may reduce congestion in an area as fewer seekers are searching for parking using ParkSIS at any given time. ParkSIS may similarly minimize aggregate distance between seekers and respective parking destinations for a plurality of users, thereby limiting overall distance travelled by ParkSIS users at any given time.

FIG. 1B schematically shows an urban area 200 comprising a home 110, a parking spot 112, a doctor's office 114, a suggested route 120, a parking spot 122, a parking spot 124, parking spots 126 and a direct route 130.

A seeker, located at home 110, engages ParkSIS via his mobile phone, on Jan. 11, 2012 at 9:00 AM, before departing from home 110 with intention to obtain a parking spot within proximity to doctor 114, based on his understanding of limited available parking in urban area 200. Seeker indicates to ParkSIS his intent to arrive at doctor 114 before 9:20 AM. The most direct route from home 110 to doctor 114 is a route 130.

Upon entering his car located at parking spot 112, ParkSIS calculates probability of finding parking within urban area 200 at estimated time of arrival of seeker based on PSD and VIF relative to users found in urban area 200. At 9:10 AM, while seeker is en route to doctor 114, ParkSIS recommends to seeker to follow suggested route 120, based on higher probability of finding a parking match via suggested route 120 than via direct route 130. The higher probability of finding a parking match and suggested route 120 may be determined, for example, using one or more of the following parameters: low demand parking spots based on historical parking exchange data, recent termination of no-parking zone and indication of potential vacator moving in the direction of his vehicle.

In an embodiment of the invention, ParkSIS displays a map depicting portions of urban area 200 comprising a schematic depiction of suggested route 120 on the seeker's mobile phone. In an embodiment of the invention, the schematic depiction comprises an arrow superposed on map of urban area 200. In an embodiment of the invention, ParkSIS voices driving directions to the seeker via the seekers mobile phone suggesting that the seeker follow suggested route 120 to doctor 114.

In an embodiment of the invention, various alternative routes (not shown) are displayed on seeker's mobile phone as potential routes for finding a parking spot. According to an embodiment of the invention, the routes are color coded and/or prioritized based on characteristics including probability of finding a parking spot.

In an embodiment of the invention, based on PSD data, ParkSIS determines that parking spots 126 are in a no-parking zone, between the hours of 9 and 10 AM on Wednesday mornings. Accordingly, ParkSIS alerts seeker as to parking limitations in parking spots 126. In an embodiment of the invention, parking spots 126 are color-coded on a map presented on seeker's mobile phone to indicate parking limitations.

In an embodiment of the invention, upon termination of a no-parking period in a region, ParkSIS determines high probability of finding a parking spot in the region.

At 9:12 AM, seeker begins to traverse route 120. ParkSIS suggests and visually displays on a map on the seeker's mobile phone parking spot 124, as a possible match with high probability of being vacated within the next 2 minutes, and parking spot of 122, with a high probability of being vacated within the next 4 minutes. At 9:13 AM, the seeker indicates to ParkSIS his desire to park in parking spot 124. ParkSIS informs occupier parked at parking spot 124 regarding the seeker's desire to park in parking spot 124 and sends details of the seeker's car. At 9:14 AM, the occupier of parking spot 124 approaches his vehicle, sees the seeker and via a hand gesture and eye contact indicates that the seeker should occupy parking spot 124 upon occupier's vacating. The seeker moves car to proximity of parking spot 124 and turns on a turning signal, indicating to other drivers his intention to enter parking spot 124 upon its vacancy. Optionally, ParkSIS instructs seeker to locate his vehicle in a location which does not obstruct traffic. For example, if ParkSIS identifies that seeker is about to arrive at parking spot 60 seconds before a potential hand off, ParkSIS may suggest that seeker wait in an area that does not obstruct traffic until estimated arrival of occupier to his vehicle. The occupier drives his car from parking spot 124, and the seeker's car enters parking spot 124. The seeker leaves his car and VIF updates ParkSIS regarding successful hand off of parking spots. The seeker walks to doctor 114 and enters doctor 114 at 9:18 AM.

According to an embodiment of the invention, ParkSIS may suggest a route of travel to a seeker which minimizes the seeker's waiting time in which a seeker will be required to wait while idling his vehicle without driving for a potential parking spot to be filled. This embodiment may be useful to enhance a user's experience while using ParkSIS, as he may continue driving without idling as he is accustomed. It may be especially suited for drivers who may wish to actively pursue parking spots without waiting for ParkSIS to coordinate a parking handoff with an occupier. According to an embodiment of the invention, upon determination of a potential match between a seeker with an occupier, ParkSIS may plan a route which seeker is to traverse to encounter destinations of maximal probability of handing off a parking spot. According to an embodiment of the invention, the route is planned to minimize idling time of a seeker waiting for a potential occupier. Preferably, idling time may be less than 30 seconds. According to an embodiment of the invention, idling time may be less than 15 seconds, or less than 10 seconds.

FIG. 1C schematically shows an urban area 300 comprising a home 210, a parking spot 212, an office building 214, a parking lot 220, and a bus stop 222.

A seeker departs from home 210, with his mobile phone, without actively engaging ParkSIS before departing on Jan. 13, 2012 at 1:00 PM, and walks to his car parked in parking spot 212. While traveling to office building 214, ParkSIS detects his movement from home 210 to parking spot 212, and from parking spot 212 in the direction of office building 214.

At 1:16 PM, based on historical user data and by engaging SIF (seeking identification function,) ParkSIS prompts the seeker using an audio function on seeker's mobile phone, “Are you going to office building and will you need parking there?”

The seeker, via his mobile phone microphone, replies, “Yes, I have a meeting at 1:30 PM.”

ParkSIS, based on VIF and PSD then informs the seeker, “There is a low probability of finding street parking near office building 214 at that time. Would you like suggestions for parking outside of your preferred parking area?”

The seeker replies, “Yes.”

ParkSIS then asks the seeker, “Would you prefer street parking at about 800 meter walk from your destination, or lot parking, about 400 meters from your destination, with a public transportation option?”

Realizing that the rainy weather is not favorable for an 800 meter walk, the seeker replies, “Lot parking.”

ParkSIS then audibly directs the seeker to parking lot 220 and informs the seeker of public transportation lines and times from bus stop 222 to office building 214.

Upon detecting seeker's parking in parking lot 220, ParkSIS updates PSD to indicate preferences of parking location based on parking interaction.

In an embodiment of the invention, ParkSIS directs seeker to taxi service upon his parking in parking lot 220. In an embodiment of the invention, ParkSIS identifies other users seeking similar taxi services to similar destinations and offers the users to share a taxi to their respective destinations.

FIG. 1D schematically shows an urban area 400 comprising a location 308, a hair salon 310, a route 312, a parking spot 314, a parking spot 316, a city hall 318 and a movie theater 320.

A seeker traverses location 308 via route 312 on Jan. 14, 2012 at 2:30 PM, while traveling at a speed not exceeding 40 kilometers per hour while looking for parking. At 2:32 PM, the seeker passes location 308 a second time and continues along a second loop of route 312. Upon identification of the seeker's multiple passes of location 308 via route 312, at 2:33 PM ParkSIS, using SIF, prompts the seeker inquiring if seeker is looking for a parking spot. The seeker indicates to ParkSIS that seeker wishes to park at hair salon 310.

At 2:34 PM, ParkSIS detects high probability of an occupier A in city hall 318 leaving his parking spot 316 within the next minute. ParkSIS alerts the seeker of possible parking spot 316 being available and indicates a walking distance of 200 meters to from the parking spot to hair salon 310. The seeker indicates that she desires a parking spot closer to hair salon 310. ParkSIS responds that closer parking will probably be available by 2:36 PM. The seeker confirms that she prefers parking available at 2:36 PM.

At 2:35 PM, ParkSIS contacts occupier B at movie theater 320 based on user heuristics indicating his potential vacating of parking spot 314. Occupier B confirms desire to vacate parking spot 314 and requests from ParkSIS to inform seeker of location of occupier B to meet and take him to his vehicle, parked in parking spot 314. At 2:36, ParkSIS informs occupier B of seeker vehicle color, model, make and location, and ParkSIS informs seeker of occupier B location. The seeker picks up occupier B in her vehicle and drives him to parking spot 314. Parking spot hand off occurs and parking spot is then occupied by seeker. Transfer of parking credit between seeker, occupier B and ParkSIS is performed, and users rate their parking experience. ParkSIS updates user profile to indicate preferences of parking location and user history based on parking interaction.

In an embodiment of the invention, in which an occupier is detected by ParkSIS as leaving a parking spot, and occupier does not accept an offer to hand off, ParkSIS may inform seekers in the area of the occupier's potentially empty parking spot. ParkSIS may offer this information to seekers based on their rating by offering information first to the highest rated seeker in the area.

In an embodiment of the invention, ParkSIS enables users to determine trust level between occupier and seeker before suggesting services such as offering a ride between users. In an embodiment of the invention, trust level may be determined using social networks. In a scenario such as the one described in FIG. 1D, users may be asked upon initiating ParkSIS use, to allow ParkSIS to access social networks to which users may be subscribed, for example, Facebook®, Twitter® or LinkedIn®. A user may be prompted to specify trust level required for specific services such as riding together with another user for example, the service offered by a seeker to an occupier to bring the occupier to his car. A user may determine that he allows ParkSIS to permit suggestions of riding together with another user only if the user shares common connections in a social network with the other user. Alternatively, a user may specify that he allows ParkSIS to permit suggestions of riding together with another user if the users are separated by 2, 3, or 4 degrees of separation.

In an embodiment of the invention, ParkSIS prompts the seeker upon parking regarding payment for parking spot 314. ParkSIS may ask the seeker if the seeker wishes to electronically pay for parking. If the seeker agrees to electronically pay for parking, ParkSIS may electronically transfer funds to a parking authority based on the seeker's credit card information which has been recorded in the seeker's user profile. Additionally or alternatively, ParkSIS may inform a parking authority of seeker's authorization to charge for parking, thereby allowing parking authority to bill the seeker. In an embodiment of the invention, the parking authority is a municipality, a private parking garage owner or an entity which effects payments to a municipality or to a private parking garage owner.

In an embodiment of the invention, ParkSIS informs the seeker of maximum time of parking allowed at parking spot 314. In an embodiment of the invention, ParkSIS alerts the seeker of time remaining from maximum parking time allowed in advance of termination of parking time.

In an embodiment of the invention, a ParkSIS user may indicate to ParkSIS if a parking ticket was received upon parking in a specific spot. ParkSIS may then update users parked in vicinity of location in which parking ticket was received regarding presence of an officer or municipal clerk giving parking tickets in the vicinity.

In an embodiment of the invention, a ParkSIS seeker may “pre-order” a parking spot in the vicinity of his or her destination. Upon receiving a request for a pre-order, ParkSIS locates a potential vacator in the vicinity of the seeker's destination. ParkSIS may open a communication channel between the seeker and the occupier to facilitate a parking hand-off in advance of the transaction.

In an embodiment of the invention, a seeker may designate his desire to park a short-term parking. ParkSIS may require seeker to determine his intended time of vacating the short-term parking spot before ParkSIS provides seeker with parking information.

FIG. 1E schematically shows an urban area 450 comprising a location 410, an area L₁, an area L₂, an area L₃, an area L₄, an area L₅, an area L₆, an area L₇, a movie theater 420, a route 474 and a route 476.

A seeker, at 410 at 12:00, engages ParkSIS to find parking information near seeker's destination, movie theater 420. ParkSIS, based on seeker's history and/or inputted preferences, determines user preferences regarding parking distance from destination, preferred cost for parking, preferred travel duration for finding a parking spot, for each of areas L₁, L₂, L₃, L₄, L₅, L₆ and L₇. ParkSIS calculates probability of seeker finding a parking spot in areas L₁, L₂, L₃, L₄, L₅, L₆ and L₇, represented as P(Lₓ, 12:00) wherein Lₓ is representative of any of areas L₁₋₇. In addition, at 12:00, ParkSIS calculates probability of seeker finding a parking spot in any of the areas at each subsequent interval of time (for example, at each minute as P(Lₓ, 12:01), P(Lₓ, 12:02), P(Lₓ, 12:03) etc.) between time of query and a predetermined time in the future. The interval of time of calculation of probabilities may vary depending on resources available to seeker's mobile communication device. The calculation of probabilities may be performed by ParkSIS database or by seeker's mobile communication device, depending on resources available to seeker's mobile communication device. ParkSIS determines for each area, navigation time (i.e. time it will take to traverse each area) to calculate routes which match user's preferences. ParkSIS determines that probability of seeker finding a parking spot in L₁, L₂, L₃ and L₄ [P(L₁₋₄, 12:00)] meeting user preferences is greater than the probability of seeker finding a parking spot in L₅, L₆ and L₇ [P(L₅₋₇, 12:00)]. In an embodiment of the invention, ParkSIS evaluates possible routes within a predetermined radius of destination, for example within 500 meters of destination. ParkSIS formulates a routing plan and suggests that seeker traverse a route 474. Route calculation is performed based on GIS data which comprises details of directions of traffic flow, permissible locations of turns and similar regulation data. At 12:01, after seeker has traversed a portion of route 474, ParkSIS recalculates probability of seeker finding a parking spot in real time, and projecting ahead for subsequent time intervals, the parking spots meeting user preferences. ParkSIS optionally suggests to seeker possibility of changing route from route 474 to increase probability of a matching parking spot by turning at a street corner or by performing a U-turn in a location in which such a turn is permissible, based on GIS data.

Seeker, at 410 at 19:00, engages ParkSIS to find parking information near seeker's destination, movie theater 420. ParkSIS calculates probability of seeker finding parking spot in areas L₁, L₂, L₃, L₄, L₅, L₆ and L₇, represented as P(Lₓ, 19:00) wherein Lₓ is representative of any of areas L₁₋₇. ParkSIS determines that probability of seeker finding a parking spot in L₅, L₆ and L₇ [P(L₅₋₇, 19:00)] is greater than the probability of seeker finding a parking spot in L₁, L₂, L₃ and L₄ [P(L₁₋₄, 19:00)]. ParkSIS suggests that seeker traverse route 476.

According to an embodiment of the invention, parking information may be provided to ParkSIS and/or by ParkSIS in terms of road segments. A road segment may be an area of a road between two points in which a driver may travel in a single, predetermined direction, without the possibility of veering from the road segment. For example, on a one way street, with reference to FIG. 1E, areas L1 and L3 may both be associated with the same road segment in which a seeker may travel in one direction (the direction of the arrow.) In the case of a two way street between points A and B (not shown) in which a seeker may travel between points A and B or between points B and A each section of road may be defined as a separate road segment. For a given destination of parking requested by a seeker, ParkSIS may calculate probability of a seeker finding a parking spot by analyzing and comparing probability of finding a parking spot for each individual road segment.

According to an embodiment of the invention a road segment is a length of a road in which a vehicle's driver will most likely travel straight and is unlikely from turning due to traffic regulations. It may be a city street block having a length of about 100 meters to about 500 meters.

According to an embodiment of an invention, driving instructions may be provided to a seeker to proceed to a certain road segment, to allow the seeker to compensate for small time differences between seeker's and occupier's arrivals, for example, in a situation where the seeker and occupier are progressing at the same road-segment at the same direction towards a parking spot, allowing the seeker to customize his/her driving speed in order to secure the handoff with the presumed occupier prior to arrival at the parking spot.

Additionally, providing information at a road segment level enhances an occupier's parking location privacy by exposing to ParkSIS users the aggregate parking spot information on the road-segment rather than correlating a specific occupier to a specific parking location. Identity of an occupier or occupier's vehicle may be provided to a seeker at a later time, only upon ParkSIS recognizing a probability of a handoff exceeding a certain level.

According to an embodiment of the invention, ParkSIS may receive information relating to certain road segments by seekers traversing certain road segments. For instance, information relating to a seeker with a specific vehicle length that passes through a road-segment having a certain distance to his/her destination correlated with ParkSIS parking categorization method described herein reveals whether that seeker parked in a specific road-segment. In a case where a user did not park in the road segment and parked after traversing the road segment, information may be provided to ParkSIS indicating absence of a parking spot with the seeker's vehicle length at that traversed road-segment. According to an embodiment of the invention, a seeker may then be prompted regarding an identified parking spot by ParkSIS. This information may then be used by ParkSIS in real-time to devise a route plan for additional seekers.

Components of a ParkSIS system in accordance with embodiments of the invention are schematically shown in FIG. 2. FIG. 2 depicts a ParkSIS 500 comprising a database 510, a processor 520 and communication module 530. Database 510 comprises map data 512 [referred to as “MAPS” in the figure], user profile data 514 [referred to as “USER PROFILES”, historical parking data 516 [referred to as “HISTORICAL PARKING”] and regulation data 518 [referred to as “REGULATIONS”]. Communication module 530 is operably linked to antenna 532.

A user 560 may access ParkSIS 500 via a mobile communication device 550. Mobile communication device comprises an antenna 552, a sensor 554, and a display 556. Communication may be facilitated between mobile communication device 550 and ParkSIS 500 through a cellular network 540.

In an embodiment of the invention, mobile communication device 550 is equipped with an application which enables communication with ParkSIS 500 when mobile communication device 550 is turned on even without direct engagement of user 560. For example, mobile communication device 550 may communicate location of the device to ParkSIS 500 while user 560 is not actively using the device.

In an embodiment of the invention, communications between ParkSIS 500 and mobile communication device 550 may be facilitated through cellular networks or through alternate networks such as a wireless local area network system (wi-fi), internet or wired systems.

In an embodiment of the invention, mobile communication device 550 employs a mobile operating system selected from the group consisting of: iOS, Android operating system, Blackberry OS and Windows Phone operating system.

In an embodiment of the invention, user 560 may interact with ParkSIS 500 via more than one mobile communication devices. For example, user 560 may have a smartphone which he uses on a daily basis and a cellular phone in his vehicle which he uses when driving, both of which may interact with ParkSIS 500.

With reference to ParkSIS 500, the communication module 530, processor 520 and database 510, may be located in one computer or on many separate computers connected via network connections. ParkSIS 500 may use cloud-based or internet based computing so that parts of processor 520 and database 510 may reside in multiple distinct geographic locations.

Map data 512 may comprise geographic information system (GIS) data from commercial providers of such data. Map data 512 may comprise geographic data from municipalities. Map data 512 may comprise information regarding municipal parking spots, road segments, street names, building numbers and directions of permitted traffic flow on roads. Map data 512 may comprise business names coordinated with their addresses and may be updated with data from telephone company databases including “white pages” and/or “yellow pages” directories.

User profile data 514 may comprise data explicitly entered by user into ParkSIS or data determined by ParkSIS relating to a user.

User profile data 514 may comprise a user's state, as determined by ParkSIS. For any given time, a user may define by his or her parking state, optionally as one of the following: occupier, potential vacator, vacator, potential seeker and seeker. User state may be explicitly defined by a user or calculated by ParkSIS based on any one or combination of parameters in user profile data 514.

Examples of user profile data 514 may comprise personal data such as: name, identification number, home address, work address and phone number. Examples of user profile data 514 may comprise vehicular data such as type of vehicle or vehicles operated by user (including model, make, year, length and color), preferred destinations for each vehicle and preferred parking profiles for each vehicle. Examples of user profile data 514 may comprise mobile communication device data such as: type of mobile communication device, number of devices having the same number, location of devices, main use of device and ownership of device. Examples of user profile data 514 may comprise personal parking data such as: data regarding a home or office parking spot in possession of the user, times of parking near work, times of parking near home, monthly amount of money spent on parking, average cruising time to find a parking spot, preferred distances to walk from parking spot to destination and average time willing to wait for a parking spot. Examples of user profile data 514 may comprise personal destination data such as: locations of frequent destinations, times of day of travel to destinations, type of parking available at destinations, parking preferences at destinations, amount of time spent at destinations. Examples of user profile data 514 may comprise rating data including the rating of the user. Examples of user profile data 514 may comprise credit data such as: number of credits of the user, billing information of user, history of credit spending in exchange for parking spots and willingness to replenish credit stock once depleted.

User profile data 514 may comprise data regarding user preferences for parking. According to an embodiment of the invention, ParkSIS categorizes a parking location under a category based on a user's parking habits. For example, a ParkSIS user may park at a specific location which is determined by ParkSIS to be off-road, based on its density of parking spots (number of recorded parkings per location) as determined by ParkSIS, multiple times every week. ParkSIS may categorize that parking location as a private, off street parking location. For example, if a user is detected parking multiple times within a certain time interval in a vicinity at a distance from the road, for example, more than 20 meters from a road, ParkSIS may determine that user parks at an off-street parking location, which may be a private parking location. If a user is detected parking multiple times in a certain time interval in a location in which user's cellular phone has limited GPS satellite accessibility, ParkSIS may determine that user parks at a multi-story or below-ground parking facility. ParkSIS, when sensing a possible parking by user, for example, through a user's cellular phone motion sensors or other sensors which may indicate parking, ParkSIS may activate a user's GPS function of his cellular phone at the time of parking to determine, based on strength of GPS signals and/or level of accuracy, type of parking as above ground or below ground.

According to an embodiment of the invention, ParkSIS, when sensing a possible parking by user, for example, through a user's cellular phone motion sensors or other sensors which may indicate parking, categorizes a parking location as on-street or off-street by measuring the destination between actual parking location and the road and correlating it with the GPS signal strength. If the destination is more than for example 20 meters and the GPS accuracy is less than 10 meters, then the parking location is an off-street parking in high probability, not an on-road parking which is close to the road.

According to an embodiment of the invention, ParkSIS categorizes a parking location under a category based on multiple users' parking habits. For example, if ParkSIS, in a first area, recognizes few parking transactions at a time at which multiple parking transactions occur at an adjacent second area, ParkSIS may categorize the first area as an area in which parking is forbidden and the second area as an area in which parking is permitted.

Categorizing a parking area or parking spot as off-road, private, underground, above ground, and similar categorizations, may be useful for ParkSIS users for many applications according to embodiments of the invention. For instance, a seeker may be offered by ParkSIS only on-street parking if the seeker desires to find parking only on-street. In addition, upon notification of a seeker of a potential parking spot, ParkSIS may clarify to the seeker the location of the parking spot by indicating its categorization.

According to an embodiment of the invention, database 510 may further comprise an advertisement module (not shown.) ParkSIS 500 may target a specific user with customized advertising based on his or her user profile data 514. For example, if ParkSIS user data 514 indicates that user regularly parks, in an underground parking lot of a specific building , ParkSIS may provide customized advertising relating to parking lots or other businesses within and in the vicinity of that building. User profile data 514 which includes user's place of residence and/or place of work may be used to provide customized advertisement based on these locations. ParkSIS is capable of providing advertising to users based on data regarding parking habits. This data may be more specific than data acquired by other known location tracking systems and may include parking preferences such as exact location of parking lot and/or exact parking type (for example home parking, street parking, etc.) According to an embodiment of the invention, ParkSIS, when sensing a possible parking by user, for example, through a user's cellular phone motion sensors or other sensors which may indicate parking, ParkSIS may activate a user's GPS function of his cellular phone at the time of parking to determine, based on strength of GPS signals and/or level of accuracy, type of parking as above ground or below ground.

According to an embodiment of the invention, user profile data 514 may be used by ParkSIS to connect between users. For example, ParkSIS may connect between users whose travel routes overlap or partially overlap, or whose parking or parking transactions occur in similar locations in order to arrange carpooling between ParkSIS users, for example, users who live and work in proximity to each other and travel to work at similar times.

Users may be able to access ParkSIS by creating a log-in profile, optionally including a user name and a password, or by using ParkSIS as a guest. ParkSIS may be equipped with a privacy module which ensures that private details which the user wishes not to share with ParkSIS, for example, name and/or phone number and/or device identification number, are not exposed to ParkSIS. For example, ParkSIS may perform one-way hashing of private details before sending information from mobile communication device 550 to communication module 530.

Examples of user profile data 514 may comprise ParkSIS user data such as frequency of request parking spots, frequency of notifying before vacating a parking spot, frequency of acceptance of ParkSIS parking suggestions. Examples of user profile data 514 may comprise user interface data such hands free devices (headphone, vehicle based speaker-phone, Bluetooth™) connected to mobile communication device, times and locations hands free devices are used, use of mobile communication device as a multimedia device and times and locations of multimedia usage.

User profile data 514 may comprise mobile communication device charging data comprising data regarding locations and types of chargers used to charge the mobile communication device. For example, a mobile communication device may recognize that a user charges his mobile communication device via a 12 Volt car charger while in his vehicle, via a USB charger while at his office and via a charger supplied by household current while at home.

Examples of user profile data 514 may comprise user application data. User application data may comprise navigation data from navigation applications and/or data from a safety application on a mobile communication device. Navigation data may comprise user destination data, preferred destination data, time to destination, average driving speeds and user current location. Initiation of a safety program on a mobile communication device, for example, may indicate to ParkSIS that user is driving in his vehicle. Initiation of a navigation application on a mobile communication device, for example, may indicate to ParkSIS that user is a potential seeker, and may require a parking spot at his destination of interest. An example of a safety application device is iOnRoad™ available at www.ionroad.com, an application which assists drivers in maintaining distance from a vehicle in front of the driver. Initiation of a safety application such as iOnRoad™ may indicate to ParkSIS that user has or will shortly begin traveling in his or her vehicle.

User profile data 514 may comprise location data. Location data for a user may be determined using satellite-based navigation systems including GPS systems and/or network connections. Network connections which may provide location data include wi-fi network connections, cellular network connections and 3G wireless network connections. For example, a user's location and/or direction and/or speed may be determined by detection of increasing distance and/or signal strength between user's mobile communication device and one cellular transceiver and decreasing distance and/or signal strength between user's mobile communication device and another cellular transceiver. In another example, a user's motion from indoors to outdoors may be detected by weakening of wi-fi connections associated with an office building or indoor café, and strengthening of 3G wireless network connections associated with open space having more exposure to 3G wireless network signals.

User profile data 514 may comprise data received from vehicle's internal sensors. Such data may include: gear of vehicle (transition from Park to Drive,) turning signal, fueling, presence of a driver and/or a passenger via a seat occupancy sensor, a reverse sensor, a front-mounted camera.

User profile data 514 may comprise sensor-based data received from a mobile communication device 550 sensor 554. A sensor 554 may comprise an accelerometer, a proximity sensor, an ambient light sensor, a temperature sensor, a Hall effect sensor, a camera, a flash or an input/output device. An input/output device may comprise a computer USB connection, an external earphone, a microphone, a speaker, a touch screen. For example, ParkSIS may identify a motion indicating a transition of a state of a user by identifying a drop in ambient light via an ambient light sensor, indicating placement of a mobile communication device 550 into a dark environment such as a pocket or a purse. Additionally, an accelerometer may detect motions resembling a walking pattern of a user, indicating potential change in status of a user. Alternatively, a microphone in a mobile communication device may record sounds associated with turning off and leaving a vehicle, such as a termination of engine noise, a vehicular trunk or door locking or initiation of a vehicular alarm system. Such a recording may indicate to ParkSIS that user has parked his vehicle. Additionally, movement entering a parking spot may be detected using a user's mobile communication device accelerometer and/or gyroscope. For example, a user's multiple transitions from driving forward to driving reverse as detected by an accelerometer and/or gyroscope may indicate a parking spot between two cars with a tight fit sufficient to allow access to cars of a certain length as user's car, but not significantly larger. Number of maneuvers (forward and reverse) may be correlated to each user's profile. For example, in a parking spot having a length of 3 meters, a proficient driver may park his car having a length of 2 meters using a total of 4 maneuvers. A less proficient driver may require 8 maneuvers to successfully park a 2 meter car in the same parking spot having a length of 3 meters.

User profile data 514 may comprise appointment data received from a mobile communication device. For example, an appointment in a user's calendar indicating “meeting at restaurant” starting at 12:00 PM may indicate to ParkSIS that user may seek parking in the area of the restaurant at about that time. In an embodiment of the invention, ParkSIS may determine probability of an occupier vacating a parking spot based on information in occupier's calendar, for example, approximate time of termination of meeting.

In an embodiment of the invention, ParkSIS may prompt user to pre-order a parking spot based on user's calendar including location and time of meeting data. In an embodiment of the invention, based on user's input of a place of meeting, ParkSIS may suggest time of a meeting based on a projection of available parking in the vicinity of the place of meeting.

User profile data 514 may comprise call data received from a mobile communication device. For example, if a user calls his mother daily from his mobile communication device upon leaving his office, identification of such a call may indicate to ParkSIS that user is leaving his office and may be traveling in the direction of his home.

User profile data 514 may comprise check-in location based data. A user may update his status on a social network by checking-in, in other words, by publishing on his social network profile that he is currently at a certain location.

Historical parking data 516 may comprise parking occupancy data for parking spots in a region. Historical parking data 516 may be based on ParkSIS usage by historical users, or may be supplied by other databases such as municipal database or parking payment databases. Various parameters for each parking spot may be included in historical parking data 516 comprising frequency of exchange of parking spots, times of day occupied, length of parking spot, cost of parking in a parking spot, enforcement of parking regulations in parking spot.

According to an embodiment of the invention, parking payment databases may be used to indicate to ParkSIS when an occupier finishes parking. An indication of finishing parking payment may signal to ParkSIS that an occupier is intending to shortly (within a minute, 30 seconds, 15 seconds, or less) leave a parking spot in which his vehicle is located. Various parking payment databases are known in the art such as “Pango” (http://en.pango.co.il/) which allows users to indicate parking in a certain area and pay for parking via an account that may be activated and/or notified via a telephone call or through a smartphone application. Such payment databases may provide information, in real time, to ParkSIS to assist in identification of occupiers who have a high probability of vacating a parking spot.

Historical parking data 516 may be supplied by cameras or other sensors, located for example, within parking meters, which detect occupancy of parking spaces. In addition, parking data may be supplied by users' cameras in mobile device. A user passing a given location comprising a parking spot may be determined by ParkSIS to be occupied or unoccupied based on images received from a user's camera while passing the location. In addition, a user seeking parking within a close proximity, for example, 200 meters from his destination may provide information to ParkSIS that no parking spots are available by user continuing to drive and to pursue a parking spot. Such information may be stored in ParkSIS database to be used to inform other drivers about parking availability.

Parking spots in different regions may be characterized by historical parking data 516 differently for different times of the day, week or month. For example, for parking spots located on a street adjacent to an office building, parking peak time may be a weekday morning. On a Saturday afternoon, the same parking spots may be characterized as “low need” parking spots, as they can be easily obtained without cruising. In another example, parking spots in a theater district may be in high demand on weekend evenings before plays, but may be in low demand on weekday mornings.

Historical parking data 516 may comprise cost data for parking spots. For example, ParkSIS may determine a cost of a parking spot based on historical transactions at similar locations at the same time of day or day of week.

Historical parking data 516 may be used in conjunction with map data 512 to characterize parking spots in different regions as on-street parking or off-street parking. For example, proximity between many parking spots may enable ParkSIS to characterize parking spots as “lot parking.”

Regulations data 518 may comprise restrictions associated with parking in a certain region. For example, a certain street may be labeled as restricted parking because of street cleaning between 8-9 AM on Tuesday mornings. In an additional example, a certain street may be labeled as parking for local residents only after 6 PM.

Regulations data may be obtained from municipality databases. In an embodiment of the invention, regulations data may be obtained from user profile data. For example, if on a certain road ParkSIS identifies many users vacating parking spots at 8:55-8:59 AM on Tuesday mornings and entering parking spots on the road at 10:00-10:10 AM on Tuesday mornings, ParkSIS may enter regulation data 518 regarding potential restrictions of parking on Tuesday mornings between 9-10 AM on the road.

In an embodiment of the invention, ParkSIS identifies that all or a high percentage of vehicles parked on a street are local residents after 6 PM on weeknights, and vacating of parking spots on the street by users who are not local residents. ParkSIS may record regulation data 518 regarding potential regarding potential restrictions of parking on non-residents after 6 PM on weeknights.

Regulation data 518 may also include parking costs for street parking and/or lot parking. ParkSIS may characterize types of parking spots as street or lot parking. For example, a parking lot may be identified by a large concentration of parked cars, or seekers waiting for entrance into a lot. Regulation data may include data from users who are prompted to indicate cost of lot parking.

Data in database 510 may include a dynamic matrix of overlaying map levels. For example, map data 512 may comprise geographical data providing locations of buildings, streets and parking spots of a given region. Map data 512 may comprise 3D information, for instance, designation of multiple levels of a parking garage. In an additional layer, user profile data 514 may provide information regarding user's current location, location of user's vehicle, place of work and/or home. In an additional layer, historical parking data 516 of ParkSIS users may be provided, for example, a display of “low need” parking spots in a given region. In an additional layer, regulation data 518 may be included for a given region, for example, providing parking restrictions in that area. Database 510 may also include parking spot cost data for each parking spot, dependent upon time of day and day of the week or day of the month.

A flow diagram depicting an algorithm 600 performed by ParkSIS in accordance with an embodiment of the invention is shown in FIG. 3A. In block 610, ParkSIS receives a vacating indication from an occupier, indicating that a parking spot will be vacated. In block 620, ParkSIS receives a seeking query from a seeker.

In block 630, ParkSIS identifies a parking spot of an occupier that matches the query of a seeker of block 620. In block 640, ParkSIS offers to an occupier to hand off a parking spot. In block 650, ParkSIS determines if occupier accepts offer to hand off a parking spot and to hand it off to a seeker.

If occupier does not accept offer to hand off, ParkSIS identifies an alternate occupier, as in block 652, and proceeds to offer to the occupier to hand off a spot as in block 640.

If occupier accepts offer to hand off, ParkSIS opens a communication channel between seeker and occupier as in block 660.

In block 670, ParkSIS determines if a parking spot was handed off to a seeker. If a parking spot was handed off, ParkSIS transfers payment of parking credit to occupier and collects payment of parking credit from parking seeker as in block 680. ParkSIS then records the parking transaction as in block 690.

If in block 670 ParkSIS determines that parking spot was not handed off to seeker, ParkSIS will record parking transaction as in block 690. Optionally, ParkSIS may return to block 630 if a seeker did not find a parking spot in order to identify another matching parking spot for seeker.

In an embodiment of the invention, ParkSIS may receive indication of vacating from an occupier as in block 610 or receive a seeking query from seeker as in block 620 in an implicit manner. In other words, a ParkSIS user (seeker, occupier or vacator) does not need to actively inform ParkSIS of his intention to vacate or seek a parking spot. The change of status of a ParkSIS user can be detected through various methods as shown in FIG. 3B.

FIG. 3B schematically shows a state diagram 700 of ParkSIS user states during the operation of ParkSIS in accordance with an embodiment of the invention.

According to an embodiment of the invention, in order to predict potential matches to facilitate hand off of parking spots between vacators and seekers, ParkSIS labels and updates, in real time, a user as having one of the five statuses (that appear as words in circles) in flow diagram 700: occupier, potential vacator, vacator, potential seeker and seeker. ParkSIS monitors transitions 710 between statuses and stores user status and location in database (FIG. 2, number 510.) ParkSIS updates user status based on any of: explicit and/or implicit data received from user and/or historical user data.

Explicit data received from user may include notification to the system of parking status. For example, if a user actively engages ParkSIS, requesting a parking spot, ParkSIS will label user as a seeker. If seeker finds a parking spot and notifies ParkSIS, ParkSIS will label the user as an occupier. If occupier notifies ParkSIS of intention to leave parking spot within an interval of time, ParkSIS may label occupier as a potential vacator or vacator.

ParkSIS may update a user status using implicit user information. Implicit user information may include user profile data 514 as described in reference to FIG. 2, number 514.

ParkSIS may selectively use sensors of a user's mobile communication device to update user status while limiting usage of mobile communication device's battery resource. For example, GPS sensors, which require relatively high battery usage, may be used to a lesser extent than other methods of determining a location of a user, for example cellular network-based location determination. In situations in which more exact location is required, GPS may be briefly turned in as per need. GPS sensing may be turned off in situations wherein user is in a static mode. In addition, GPS sensors may be turned off when GPS signal strength is weak, such as indoors. In addition, when user's mobile communication device is connected to a wi-fi network, GPS sensors may be turned off.

With reference to FIG. 3B, an exemplary transition in user state from occupier to potential vacator, to vacator may be described as follows, as performed by ParkSIS functions including VIF. ParkSIS records user as parked at a street parking spot, at a known destination, and designates user as an occupier. ParkSIS records user entering a business meeting in a “residential” area based on GPS location-based detection. GPS signaling is then shut off by ParkSIS. After two hours, ParkSIS detects user's mobile phone leaving a wi-fi network and detects an improvement in 3G connection. ParkSIS designates user as a potential vacator. User's GPS detection is turned on by ParkSIS. ParkSIS detects the distance between user's location and user's vehicle decreasing. ParkSIS determines approximate time of arrival at parking spot, taking into account user's average walking speed. ParkSIS accesses historical data of user's parking in same area at same time of day and day of week, and calculates probability that user will vacate parking spot. If probability exceeds a predetermined level, for example 75%, ParkSIS designates user as vacator, and initiates a process of identification of seekers in area and offering to vacator to exchange his spot with another ParkSIS user.

With reference to FIG. 3B, an exemplary transition in user state from vacator to potential seeker, to seeker may be described as follows, as performed by ParkSIS functions including SIF. ParkSIS identifies user vacating a parking spot and beginning to drive, in the direction of her home in a residential area. ParkSIS detects driving of vehicle and designates user as a potential seeker. ParkSIS detects that user approaches a neighborhood in which she lives. ParkSIS calculates probability of seeking parking relative to previous times she had traveled via the same route at the same time of day and/or day of the week. When probability of seeking a parking spot exceeds a predetermined level, for example 55%, ParkSIS designates user as a seeker and initiates a process of identification of vacators in area who meet seeker's parking preference criteria.

According to an embodiment of the invention, a user may subscribe to transitions 710 in a specific area, thereby utilizing ParkSIS “subscription service.” For example, if a user is interested in parking information on weekdays between 9 and 10 AM in a city center, he may indicate this interest to ParkSIS, which will provide a list, optionally in real time, of parking information related to transitions of users from “occupier” status to “potential vacator” status, or from “potential vacator” to “vacator” status. Transitions updated in the list may be based on implicit data received from users, or may be based on explicit data entered by users either during or before the time of interest. The user subscribed to updates on transitions 710 may then initiate contact, via ParkSIS, to a user who underwent status change. In an embodiment of the invention, a vacator may initiate a bidding auction among subscribers allowing vacator to hand off to highest paying bidder. In another embodiment of the invention, a seeker may initiate bidding for a parking spot among potential vacators who are subscribed to transitions 710 in his area.

In another example of ParkSIS subscription service, a user who owns a private off-street parking spot in an area of high demand may subscribe to parking information related to transitions of users from “potential seeker” to “seeker” in the vicinity of his private off-street parking spot at times when his parking spot is vacant. The user may then contact, via ParkSIS, users who underwent transitions and offer use of his parking spot. Payment for his parking spot may be transferred from seeker to parking spot owner using any of the aforementioned methods.

There is further provided, in accordance with an embodiment of the invention, a method for assisting a seeker of a parking spot comprising: receiving a request for a parking spot subject to at least one constraint, from a seeker; receiving a plurality of notifications relating to availability of a parking spot meeting the at least one constraint; and providing to the seeker a routing plan relating to a route to be traversed by the seeker to assist the seeker of a parking space that satisfies at least one constraint, the route being responsive to the received notifications. Optionally, the notifications relating to availability of a parking spot comprise an indication of a possibility of an occupied parking spot being vacated by an occupier whose vehicle is parked in a parking spot meeting the parking constraint. Optionally, an indication of a possibility of an occupied parking spot being vacated by an occupier comprises an indication that probability of an occupied parking spot meeting the parking constraint being vacated has exceeded a predetermined level. Optionally, the routing plan of the seeker is updated based on receipt of notifications relating to availability of a parking spot, as the seeker traverses the route defined by the routing plan. Optionally, notifications relating to availability of a parking spot meeting the at least one constraint are each related to a specific road segment. Optionally, the method further comprises estimating a seeker's time of arrival at a parking spot that meets at least one constraint. Optionally, the route is provided based on real time traffic information. Optionally, the method further comprises coordinating communication between the seeker and the occupier to facilitate handing off of the parking spot. Optionally, the method further comprises handing off of the parking spot from the occupier to the seeker. Optionally, the method further comprises electronically collecting a payment from the seeker upon completion of the hand off of the parking spot. Optionally, the method further comprises electronically transferring a payment to the occupier upon hand off of the parking spot. Optionally, a notification of a possibility of a parking spot being vacated is provided without the explicit instruction of the occupier. Optionally, a notification of a possibility of a parking spot being vacated is determined using an occupier's mobile communication device. Optionally, a notification of a possibility of a parking spot being vacated is determined based on a payment by an occupier to a parking payment database. Optionally, a notification of a possibility of a parking spot being vacated is determined based on a change in occupier location or based on a sound detected by occupier's mobile communication device. Optionally, a request from a seeker to park is received without the explicit instruction of the seeker. Optionally, a request from a seeker to park is determined based on a change in seeker location or based on a sound detected by seeker's mobile communication device. Optionally, a routing plan is provided to the seeker through seeker's mobile communication device. Optionally, a possibility of an occupied parking spot being vacated by an occupier whose vehicle is parked in a parking spot meeting the parking constraint is based on user history stored in a database. Optionally, the routing plan provided to the seeker minimizes the time the seeker will idle his car waiting for an occupier to exchange a parking spot. Optionally, the routing plan provided to the seeker comprises a route longer than the shortest route and/or the quickest route between the seeker's location and the seeker's destination. Optionally, the routing plan provided to the seeker directs the seeker to travel without idling for longer than 30 while searching for a parking spot. Optionally the routing plan provided to the seeker directs the seeker to travel without idling for longer than 15 seconds while searching for a parking spot. Optionally, the method further comprises categorizing a type of parking spot of an occupier. Optionally, categorizing the type of parking spot is performed based on historical parking data. Optionally, categorizing the type of parking spot is performed based on user data. Optionally, categorizing the type of parking spot is performed based on GPS data. Optionally, requests for a parking spot are received from multiple seekers for a parking spot in a common given area and routing plans are provided simultaneously to multiple seekers. Optionally, routing plans are provided on an aggregate basis in order to reduce overall time of seeking parking spots for all users in a given area. Optionally, routing plans are provided on an aggregate basis in order to reduce overall distance between seekers and respective parking spots in a given area. Optionally, the method further comprises providing an advertisement to an occupier based on categorization of the occupier parking spot type.

There is further provided, in accordance with an embodiment of the invention, a system, comprising a processor, a communication module and a database, configured to provide a method for assisting a seeker of a parking spot. Optionally, the database comprises data selected from the group consisting of: historical parking data, user profile data, map data, real time data and regulation data.

In the description and claims of the present application, each of the verbs, “comprise,” “include” and “have,” and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims

1. A method of assisting a seeker of a parking spot comprising:
receiving a request for a parking spot subject to at least one constraint, from a seeker;
receiving a plurality of notifications relating to availability of a parking spot meeting the at least one constraint;
providing to the seeker a routing plan relating to a route to be traversed by the seeker to assist the seeker of a parking space that satisfies at least one constraint, the route being responsive to at least one of the received notifications, the at least one notification comprising an indication of a possibility of an occupied parking spot being vacated by an occupier whose vehicle is parked in a parking spot meeting the parking constraint; and
determining predicted arrival times of the seeker and the occupier at the occupied parking spot, wherein determining predicted arrival times of the occupier at the occupied parking spot comprises estimating the predicted arrival time based on at least one of the time it takes the occupier to arrive at the parking spot and the time it takes the occupier's vehicle to leave the parking-spot;
wherein the routing plan provided to the seeker minimizes the difference between the predicted arrival times, including customizing driving speed.

2. (canceled)

3. The method according to claim 1 wherein indication of a possibility of an occupied parking spot being vacated by an occupier comprises an indication that probability of an occupied parking spot meeting the parking constraint being vacated has exceeded a predetermined level.

4. The method according to claim 1 wherein the routing plan of the seeker is updated based on receipt of notifications relating to availability of a parking spot, as the seeker traverses the route defined by the routing plan.

5. The method according to claim 1 wherein notifications relating to availability of a parking spot meeting the at least one constraint are each related to a specific road segment, wherein a road segment comprises a road between two points in which a driver may travel in a single, predetermined direction, without the possibility of veering from the road segment.

6. The method according to claim 1 wherein determining predicted arrival times of the seeker at the occupied parking spot comprises estimating the predicted arrival time based on at least one of distance, historical traffic data, seeker profile, historical driving patterns of seeker and real time traffic data.

7. The method according to claim 1 wherein the route is provided based on real time traffic information.

8. The method according to claim 1 further comprising coordinating communication between the seeker and the occupier to facilitate handing off of the parking spot.

9. The method according to claim 8 further comprising handing off of the parking spot from the occupier to the seeker.

10. The method according to claim 8 further comprising electronically collecting a payment from the seeker upon completion of the hand off of the parking spot.

11. The method according to claim 10 further comprising electronically transferring a payment to the occupier upon hand off of the parking spot.

12. The method according to claim 1 wherein a notification of a possibility of a parking spot being vacated is provided without the explicit instruction of the occupier.

13. The method according to claim 1 wherein a notification of a possibility of a parking spot being vacated is determined using an occupier's mobile communication device.

14. The method according to claim 1 wherein a notification of a possibility of a parking spot being vacated is determined based on a payment by an occupier to a parking payment database.

15. The method according to claim 1 wherein a notification of a possibility of a parking spot being vacated is determined based on a change in occupier location or based on a sound detected by occupier's mobile communication device.

16. The method according to claim 1 wherein a request from a seeker to park is received without the explicit instruction of the seeker.

17. The method according to claim 16 wherein a request from a seeker to park is determined based on a change in seeker location or based on a sound detected by seeker's mobile communication device.

18. The method according to claim 1 wherein a routing plan is provided to the seeker through seeker's mobile communication device.

19. The method according to claim 1 wherein a possibility of an occupied parking spot being vacated by an occupier whose vehicle is parked in a parking spot meeting the parking constraint is based on user parking history stored in a database.

20. The method according to claim 1 wherein the routing plan provided to the seeker minimizes the time the seeker will idle his car waiting for an occupier to exchange a parking spot.

21. The method according to claim 20 wherein minimizing the seeker's idle time comprises providing a route longer than the shortest route and/or the quickest route between the seeker's location and the seeker's destination.

22. The method according to claim 20 wherein the routing plan provided to the seeker directs the seeker to travel without idling for longer than 30 seconds while searching for a parking spot.

23. The method according to claim 22 wherein the routing plan provided to the seeker directs the seeker to travel without idling for longer than 15 seconds while searching for a parking spot.

24. The method according to claim 1 further comprising categorizing a type of parking spot of an occupier based on one of the occupier's parking habits, historical parking data and GPS data.

25. (canceled)

26. (canceled)

27. (canceled)

28. The method according to claim 1 wherein requests for a parking spot are received from multiple seekers for a parking spot in a common given area and wherein routing plans are provided simultaneously to multiple seekers, said routing plans provided on an aggregate basis in order to reduce overall time of seeking parking spots for all users in a given area or to reduce overall distance between seekers and respective parking spots in a given area.

29. (canceled)

30. (canceled)

31. The method according to claim 1 further comprising providing an advertisement to an occupier based on categorization of the occupier parking spot type.

32. A system, comprising a processor, a communication module and a database, configured to provide a method for assisting a seeker of a parking spot according to claim 1.

33. The system according to claim 32 wherein the database comprises data selected from the group consisting of: historical parking data, user profile data, map data, real time data and regulation data.

34. A method for assisting a seeker of a parking spot comprising:
receiving a request for a parking spot subject to at least one constraint, from a seeker;
receiving a plurality of notifications relating to availability of a parking spot meeting the at least one constraint; and
providing to the seeker a routing plan relating to a route to be traversed by the seeker to assist the seeker of a parking space that satisfies at least one constraint, the route being responsive to at least one of the received notifications, wherein the request for a parking spot is received implicitly.

35. The method of claim 34, wherein the implicit request for a parking spot is determined based on one of a change in seeker location and a sound detected by seeker's mobile communication device.
